(19) United States
(12) Patent Application Publication
(10) Pub. No.: US 2011/0317067 A1
(43) Pub. Date: Dec. 29, 2011

(54) DEVICE HAVING FUNCTIONS OF HIGH DEFINITION CONVERSION AND AUDIO SUPPORTING

(76) Inventor: MING-HAN HSIEH, Zhonghe City (TW)

(21) Appl. No.: 12/826,636

(22) Filed: Jun. 29, 2010

(51) Int. Cl. H04N 7/015

(52) U.S. Cl. 348/441; 348/E07.004

(57) ABSTRACT

Provided is a device having functions of high definition conversion and audio supporting, including an analog video and audio unit, an extended display identification data (EDID) electrically-erasable programmable read-only memory (EEPROM) module, an ADC, a high-definition multimedia interface (HDMI) module, a memory control unit (MCU), and a power control module. The ADC converts an analog signal received through the analog video and audio unit into a digital signal, which is then converted by the HDMI module into an image signal to be applied to a displaying device (such as a displaying screen or a TV set). The EDID EEPROM module provides the optimum resolution to the displaying device. As such, WUXGA (Widescreen Ultra Extended Graphics Array) resolution can be realized and audio effect is supported.

### (a) TECHNICAL FIELD OF THE INVENTION

The present invention generally relates to a device having functions of high definition conversion and audio supporting, which is simple, practical, and convenient to use, effectively increases displaying resolution of screen, supports HDCP (High-bandwidth Digital Content Protection), requires no installation of driver programs, and provides an extended displaying mode.

### (b) DESCRIPTION OF THE PRIOR ART

A displaying device plays an important role as a bridge between people and data transmission and must perform the operation in the best way to satisfy the most criticizing eyes of general consumers. Thus, all kinds of consumer products, including portable devices, information devices, or video devices, are involved with increasingly demanded displaying result and are also developed to meet the needs of applications and environments of use of end-user products.

The currently available video interfaces include VGA (Video Graphics Array), DVI (Digital Visual Interface), and HDMI (High-Definition Multimedia Interface), or alternatively, a USB is used to directly couple to DVI. All these techniques provide a maximum resolution of 4:3 and thus a standard of 1600×1200 maximum resolution for UXGA (Ultra eXtended Graphics Array). And, this does not include audio components, so that a user must arrange for an additional output for audio signals. This is certainly troublesome.

The current trend in the recent years is widescreen displaying, which is commonly accepted by the general consumers. To satisfy the needs of the modern society, new versions of technology in this field are emerging. The 4:3 resolution displaying is fading away and getting out of market. Consequently, the UXGA displaying devices no longer satisfy the needs of the market. The substitute, newly-developed WUXGA (Widescreen Ultra eXtended Graphics Array) that is a new version of UXGA supporting HDMI resolution and showing a maximum definition of 1920×1200 and an aspect ratio of 16:10 and includes audio signals is becoming a new trend of the current market.

Thus, the present invention aims to provide a device that follows the current trend to provide improvement of screen displaying resolution, supporting to HDCP and extended displaying mode, without installation of driver programs.

### SUMMARY OF THE INVENTION

An objective of the present invention is to provide a device having functions of high definition conversion and audio supporting, which is simple, practical, and convenient to use, effectively increases displaying resolution of screen, supports HDCP (High-bandwidth Digital Content Protection), requires no installation of driver programs, and provides an extended displaying mode. In architecture, the device according to the present invention comprises an analog video and audio unit, an extended display identification data (EDID) electrically-erasable programmable read-only memory (EEPROM) module, and analog-to-digital converter (ADC), a high-definition multimedia interface (HDMI) module, a memory control unit (MCU), and a power control module. The analog video and audio unit is connected to a computer system to receive an output of video and audio signals from the computer system. The EDID EEPROM module is connected to the computer system and comprises an EEPROM and EDID. The ADC is connected to the analog video and audio unit to receive and convert detection results of video and audio signals into digital image. The HDMI module is connected to the ADC and a displaying device. The MCU is connected to the EDID EEPROM module, the ADC, and the HDMI module and functions for storage of data and detection of signal frequency and controls of the ADC and the HDMI module, and also functions to carry out operations of reading and writing of the EDID EEPROM module. The power control module supplies electrical power. When the computer system supplies an output of record of image through analog video and audio unit in the form of analog signal, the analog signal is converted by the ADC into a corresponding digital signal, which is then converted by the HDMI module into a video image to be displayed on the displaying device, and meanwhile, the EDID module communicates the computer system to identify and transmit resolution of video output to the MCU, which makes the ADC and the HDMI module carrying out necessary corrections, so as to obtain a displaying image or an extended displaying mode with a resolution corresponding to Widescreen Ultra Extended Graphics Array (WUXGA) and supporting audio effect.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a block diagram showing an embodiment of the present invention.

FIG. 2 is a flow chart showing a method of increasing displaying resolution of a displaying device according to the present invention.

FIG. 3 is a flow chart showing a method of extended displaying mode according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

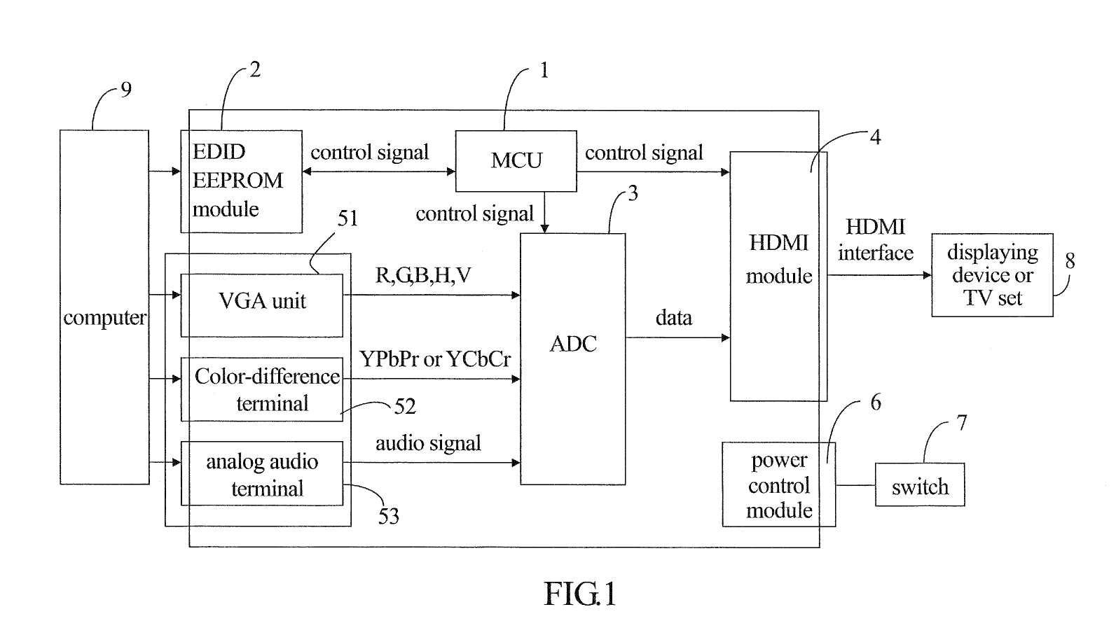

Referring to FIG. 1, a device having functions of high definition conversion and audio supporting according to a preferred embodiment of the present invention comprises a memory control unit (MCU) 1, an extended display identification data (EDID) electrically-erasable programmable read-only memory (EEPROM) module 2, an analog-to-digital converter (ADC) 3, an HDMI (High-Definition Multimedia Interface) module 4, an analog video and audio unit 5, and a power control module 6.

Referring to FIG. 1, the MCU 1 provides operations of data storage and signal frequency detection, and also controls the ADC 3 and the HDMI module 4, and performs operations of reading and writing of the EDID EEPROM module 2.

The EDID EEPROM module 2 is connected to a computer system 9 and comprises an EEPROM and contains EDID. The EEPROM is different from other types of parallel memory in that data stored in the EEPROM can be erased by applying a specific electric voltage for re-writing of new data without any irradiation of ultraviolet light or being removed. The EEPROM has four operation modes, including reading, writing, erasing, and checking. In a reading operation, the memory chip receives a low voltage Vcc (normally +5V) for operation and in a programming and writing operation, the memory chip receives, through WP pin, a programming voltage (which is usually 0V or +5V depending on types of chip used) and writing data through I2C (Inter Integrated Circuit) interface or SPI (Serial Peripheral interface). To ensure correct writing, each data block must be checked through a checking operation after writing. The EDID performs automatic adjustment of the quality of resolution according to the resolution of video output. In other words, a user is not bored for adjusting the resolution of an output device to mate a personal computer to be interfered therewith and the device will automatically set the resolutions of the two systems to the same. The EDID EEPROM module 2 serves as an interfacing communication channel between the MCU 1 and the computer 9, timely updating communication data between the MCU 1 and the computer 9 and using a display data channel (DDC) to transmit signals so as to realize the control of resolutions of two or more displaying devices.

The ADC 3 is connected to the analog video and audio unit 5 to instantly convert analog signals into digital signals based on the detection result of video and audio signals of the analog video and audio unit 5 in order to supply the digital signals to the HDMI module 4. The ADC 3 is connected through the analog video and audio unit 5 to the computer system 9 and is also connected to the MCU 1.

The HDMI module 4 is connected to the ADC 3 and a displaying device 8 (such as a displaying screen of a personal computer or a television set), and also forms communication relationship with the MCU 1. The HDMI module 4 provides standards of video interface that allows for digitalized transmission for enhancing displaying quality of the displaying device 8.

The analog video and audio unit 5, which is also known as “digit input interface”, works as a digital connection between a personal computer 9 and the displaying device 8 to provide a single and universal interface standard between a host device and a display thereby providing a low-cost and high-speed digital connection and standard between a video source and a display. According to the present invention, video and audio signals from the computer system 9 are transmitted through the analog video and audio unit 5 to the ADC 3. The analog video and audio unit 5 comprises a VGA (Video Graphics Array) unit 51, a color-difference (YPbPrc or YCbCr) terminal 52, an analog audio terminal 53, of which the VGA unit 51 and the color-difference terminal 52 are used to transmit an image from the computer system 9, while the analog audio terminal 53 is used to transmit an audio signal from the computer system 9.

The power control module 6 controls regulation of electrical voltage and provides electrical voltages and currents to meet the need of each of these. The power control module 6 comprises an ON/OFF switch 7.

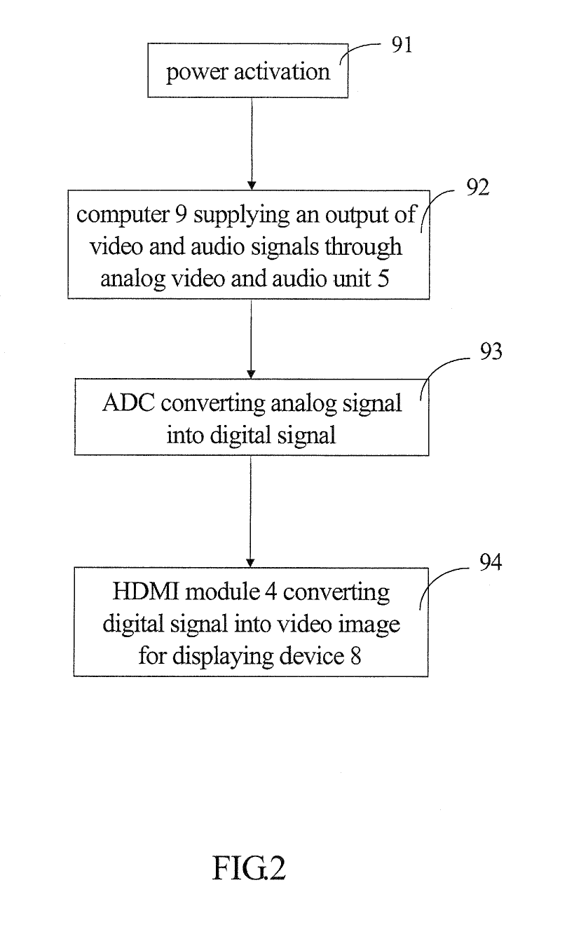

Referring to FIG. 2, a method for enhancing displaying resolution a displaying device according to the present invention comprises the following steps:

Step 91, in which power is activated, whereby when the switch 7 turns on a power supply, the power control module 6 supplies a required current to each unit;

Step 92, in which a computer system 9 supplies an output of video and audio signals through the analog video and audio unit 5, whereby the computer system 9 supplies records of color image through the color-difference terminal 52 and analog audio signals through the analog audio terminal 53 as analog signals;

Step 93, in which the ADC 3 receives and converts the analog signals into corresponding digital signals and further applies the converted digital signals to the HDMI module 4; and

Step 94, in which the HDMI module 4 converts the digital signals into a video image to be displayed on the displaying device 8, wherein the HDMI module 4 contains built-in HDCP (High-Bandwidth Digital Content Protection), which protects digitalized video and audio data from unauthorized duplication during transmission through DVI (Digital Visual Interface) or and also maintains desired image quality.

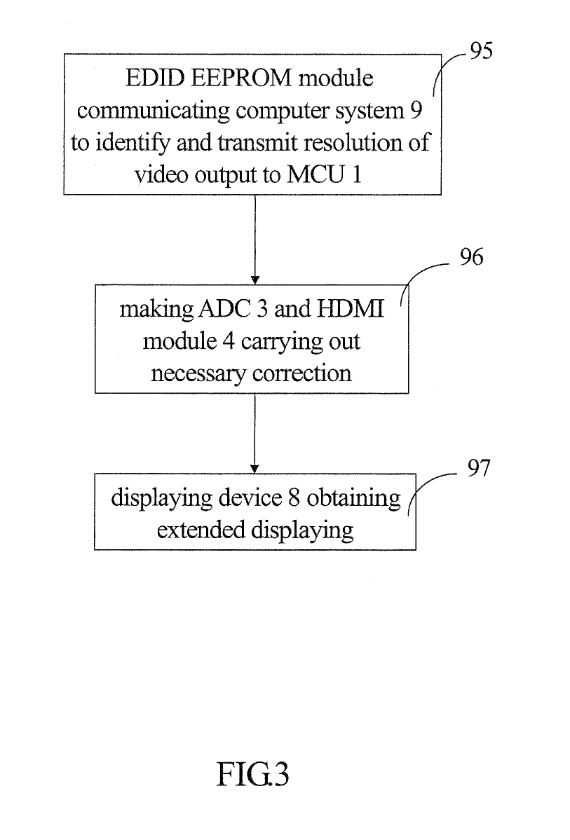

Referring to FIG. 3, a method of extended displaying mode according to the present invention comprises the following steps:

Step 95, in which the EDID EEPROM module 2 makes communication with the computer system 9 at the time when Step 93 is being executed, so as to identify and transmit the resolution of video output to the MCU 1;

Step 96, in which the ADC 3 and the HDMI module 4 are caused to carry out necessary correction; and

Step 97, in which, after Step 96, an extended displaying mode can be realized for a case where the HDMI module 4 is connected to two displaying devices 8, whereby a desired displaying effect of WUXGA (Widescreen Ultra eXtended Graphics Array) having maximum resolution of 1920×1200 and aspect ratio of 16:10 of the so-called UXGA (Ultra eXtended Graphics Array) format can be realized.

In summary, the present invention provides a device having functions high definition conversion and audio supporting, and the device requires no installation of driver programs, making it easy and time-saving, and supports WUXGA displaying and audio function and also provides an extended displaying mode for dual screens so as to effectively overcome the “bottle neck” of the conventional screen resolution and allows for multimedia operation.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A device, comprising:
an analog video and audio unit, which is adapted to connect to a computer system to receive an output of video and audio signals from the computer system;
an extended display identification data (EDID) electrically-erasable programmable read-only memory (EEPROM) module, which is adapted to connected to the computer system, the EDID EEPROM module comprising an EEPROM and EDID;
an analog-to-digital converter (ADC), which is connected to the analog video and audio unit to receive and convert detection results of video and audio signals into digital image;
a high-definition multimedia interface (HDMI) module, which is connected to the ADC and is adapted to connect to a displaying device;
a memory control unit (MCU), which is connected to the EDID EEPROM module, the ADC, and the HDMI module and which functions for storage of data and detection of signal frequency and controls of the ADC and the HDMI module, and also functions to carry out operations of reading and writing of the EDID EEPROM module; and
a power control module, which supplies electrical power;
wherein when the computer system supplies an output of record of image through the analog video and audio unit in the form of analog signal, the analog signal is converted by the ADC into a corresponding digital signal, which is then converted by the HDMI module into a video image to be displayed on the displaying device, and meanwhile, the EDID EEPROM module communicates the computer system to identify and transmit resolution of video output to the MCU, which makes the ADC and the HDMI module carrying out necessary corrections, so as to obtain a displaying image or an extended displaying mode with a resolution corresponding to Widescreen Ultra Extended Graphics Array (WUXGA) and supporting audio effect.

2. The device according to claim 1, wherein the HDMI module comprises high-bandwidth digital content protection built therein.
